(19) United States
(12) Patent Application Publication
(10) Pub. No.: US 2017/0272544 A1
(43) Pub. Date: Sep. 21, 2017

(54) Computer System and Method for Sandboxed Applications

(71) Applicant: Tangentix Limited, Sheffield (GB)

(72) Inventors: Paul Edmund Fleetwood Sheppard, Glasgow (GB); Edward Michael French, Holmfirth (GB); Michael Athanasopoulos, Sheffield (GB); Michael Roper, Bently (GB)

(21) Appl. No.: 15/458,121

(22) Filed: Mar. 14, 2017

(30) Foreign Application Priority Data
Mar. 15, 2016 (GB) 1604362.2

(51) Int. Cl. H04L 29/08; A63F 13/35; G06F 9/54; G06F 9/445; G06F 21/53

(52) U.S. Cl. CPC H04L 67/34; G06F 8/61; G06F 21/53; G06F 9/546; A63F 13/35; G06F 2209/541

(57) ABSTRACT

A client device downloads a sandboxed application contained within a sandbox. A relay server external to the client device is arranged to pass messages between the sandboxed application and a privileged application of the client device. A content server provides a content application which is downloaded and installed on the client device by the privileged application in response to a request from the sandboxed application received via the relay server.

### TECHNICAL FIELD

This application claims the benefit of U.K. Utility Application No. GB1604362.2 filed in the United Kingdom on 15 Mar. 2016, the disclosure of all of which is incorporated by reference herein in their entirety.

### BACKGROUND

The present disclosure relates generally to the field of computers and computer systems. More particularly, the described examples concern a computer system and method operable for use with an application which is contained within a sandbox on a client device.

There is a large and ongoing demand for systems that enable executable interactive content, such as video games, to be delivered by downloading to a client device over a network. Further, there is a need to operate the downloaded content safely and securely on the client device, without introducing malicious code such as a virus. Therefore, many computer devices use sandboxing as a security mechanism. A downloaded application (i.e. an executable file or program) is operated within a sandbox, as a container which restricts access by that application only to a subset of the resources of the client device. The sandbox may confine the application to access only certain areas within memory (RAM) and storage (disk space) of the device, so that the sandboxed application is isolated away from other areas—in particular to prevent the sandboxed application from accessing or interfering with other programs and other data held on the client device.

A sandbox may be implemented in a number of different ways, but increasingly is being built into the operating system of the client device. Here, the operating system implements a security model which confines applications each within their own respective sandbox. The sandbox typically limits the ability of the application to read, write or delete files except within a limited scope, and may further restrict access to underlying functionality or components of the hardware of the client device (e.g. block access to a microphone, camera, etc.). Conversely, the sandbox may restrict monitoring of the application by other programs on the client device.

A difficulty arises in that the sandbox may be effective to such an extent that the sandboxed application is rendered functionally inoperative. That is, the application confined within the sandbox is now unable to operate in the intended manner. This difficulty arises especially for legacy applications which have not been designed and built to operate within the particular sandbox implementation of the client device.

It is now desired to provide a system and method which will address these, or other, limitations of the current art, as will be appreciated from the discussion and description herein.

### SUMMARY

According to the present invention there is provided a system, apparatus and method as set forth in the independent claims. Additional features of the invention will be apparent from the dependent claims, and the description which follows.

In one example there is described a computer system, comprising: a client device having hardware including at least a processor and a memory configured to download a sandboxed application and to contain the sandboxed application within a sandbox, and configured to operate a privileged application which is not contained within the sandbox on the client device; a relay server external to the client device, arranged to pass messages between the sandboxed application and the privileged application of the client device; and a content server arranged to provide a content application, which is downloaded and installed on the client device by the privileged application in response to a request from the sandboxed application received via the relay server.

In one example there is described a client device comprising hardware including at least a processor and a memory configured to: download a sandboxed application and to contain the sandboxed application within a sandbox; operate a privileged application which is not contained within the sandbox on the client device; and download and install a content application on the client device by the privileged application in response to a request from the sandboxed application received via a relay server external to the client device and arranged to pass messages between the sandboxed application and the privileged application of the client device.

In one example there is described a method for a client device in a computer system, the method comprising: downloading a sandboxed application and containing the sandboxed application within a sandbox; operating a privileged application which is not contained within the sandbox on the client device; and downloading and installing a content application on the client device by the privileged application in response to a request from the sandboxed application received via a relay server external to the client device and arranged to pass messages between the sandboxed application and the privileged application of the client device.

In one example there is provided a tangible non-transient computer readable medium having recorded thereon instructions which, when executed, cause a computer to perform the steps of any of the methods defined herein.

### BRIEF DESCRIPTION OF THE DRAWINGS

For a better understanding of the invention, and to show how example embodiments may be carried into effect, reference will now be made to the accompanying drawings in which:

FIG. 1 is a schematic diagram of an example system;

FIG. 2 is a schematic diagram showing the example system in more detail;

FIG. 3 is a schematic view showing the example system in more detail;

FIG. 4 is a schematic diagram showing a process in the example system;

FIG. 5 is a schematic diagram showing a process in the example system;

FIG. 6 is a schematic view showing an example user interface;

FIG. 7 is a schematic diagram showing a process in the example system;

FIG. 8 is a schematic diagram showing a process in the example system; and

FIG. 9 is a schematic flow diagram showing an example content delivery method.

### DETAILED DESCRIPTION

The example embodiments will be discussed particularly with reference to a gaming system, for ease of explanation and to give a detailed understanding of one particular area of interest. However, it will be appreciated that other specific implementations will also benefit from the principles and teachings herein. For example, the example embodiments can also be applied in relation to tools for entertainment, education, engineering, architectural design or emergency planning. Other examples include systems providing visualizations of the human or animal body for teaching, training or medical assistance. There are many specific environments which will benefit from delivering interactive executable multimedia content to client devices across a network. Thus, references to a game or video game are intended to refer to example uses of the teachings herein and should be adapted as appropriate for other example embodiments.

Some of the described examples provide a system which allows graphically intensive interactive multimedia content, such as video games, to be delivered across a network, and which further permits functional operation of the content even when sandboxes are employed on the client device. For illustration, a legacy video game application may be distributed over a network to a client device which uses sandboxes to contain applications, yet still achieve full intended operational functionality on the client device.

As a further benefit, legacy games may be to be delivered whilst avoiding substantial modification or reengineering of the game code. As a result, legacy game code is more readily adapted into a digital online delivery channel, without adversely impacting the already tested and quality assured reliability of that game code. These legacy games can be quickly and easily packaged for delivery as a download over a network rather than, as may have been originally intended, requiring delivery by physical media such as an optical disc.

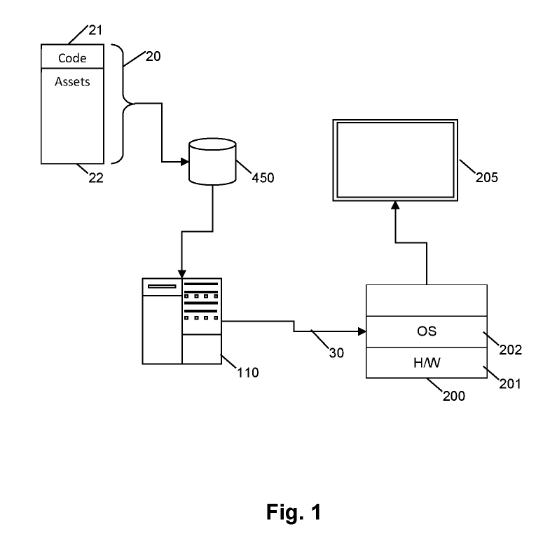

FIG. 1 is a schematic diagram of an example system for delivering interactive executable content, such as a video game application, across a network 30. The example content delivery system includes at least one server device 110 and at least one client device 200 which are coupled together by the network 30. The underlying software and hardware components of the server device 110, the client device 200 and the network 30 may take any suitable form as will be familiar to those skilled in the art. Also, it will be appreciated that practical examples are intended to operate at a globally significant scale, wherein many tens, hundreds or thousands of servers support a population of client devices even in the millions.

Typically, the server device 110 includes relatively powerful computers with high-capacity processors, memory, storage, network interfaces, etc. The client device 200 may take a variety of forms, including hand-held cellular phones, PDAs and gaming devices (e.g. Sony PSP™, Nintendo DS™, etc.), games consoles (XBOX™, Wii™, PlayStation™), set-top boxes for televisions, or general purpose computers in various formats (tablet, notebook, laptop, desktop). These diverse client platforms suitably provide local storage, memory, processing power, and connectivity interfaces, and contain or are associated with a form of visual display unit such as a display screen or other visual display device (e.g. LCD/LED monitor, touch screen, video goggles or holographic projector).

As shown in FIG. 1, the client device 200 suitably includes physical hardware H/W 201, and an operating system OS 202. The hardware layer 201 suitably includes user input devices, such as keyboard, mouse, game pad etc., local storage devices such as a hard disk drive HDD, audio/video A/V output devices such as a sound card or video card to reach a monitor and speakers, and network interface connections NIC to reach external network locations.

The network 30 is suitably a wide area network (WAN). The network 30 may include by wired and/or wireless connections. The network 30 may include peer to peer networks, the Internet, cable or satellite TV broadcast networks, or cellular mobile communications networks, amongst others.

In the example embodiment, the server 110 and the client device 200 are arranged to deliver one or more content applications 20 across the network 30. In the following example, data flows flow substantially unidirectionally as a download from the server 110 to the client 200.

The content 20, such as a video game, typically includes one or more sections of executable code 21, and a relatively large volume of data assets 22. In a video game, the assets 22 may include many multimedia game assets (i.e. 3D objects and related environmental data, video cut scenes, 2D image files and audio files). The code 21, and the assets 22, have been traditionally designed and arranged to be delivered on an optical disc or other the physical recording medium. Given the familiarity of the industry with the optical disc delivery format, it is also convenient to design and deliver new games in these traditional formats. In particular, issues such as quality assurance and security are well understood and highly developed for traditional games applications on physical media. Hence, it is advantageous to be able to maintain the current design and delivery process, but to add a simple and low-cost method for transferring the created original content into a form which is more suitable for digital downloads.

As a further consideration, there is also a large catalogue of legacy content, such as video games, which have already been created and distributed using optical discs or memory cartridges or other physical media. It is relatively difficult and expensive to change these legacy games retrospectively, and thus it is desired to provide a system which enables digital downloads of these games. Repackaging content into a downloadable form has many further advantages for the games industry, in particular to reach new customers or to reach new markets or territories.

In the example embodiments, the client device 200 executes the game code 21 to control an interactive virtual environment that will be represented visually through a display device 205. The environment will depend upon the nature of the content, but a car racing game will typically provide a racetrack environment, while a first person role play game provides a city environment, as examples. The environment is virtual, in that it is produced within the hardware and appears on the display screen. The environment is interactive in that the user may command changes to the environment (e.g. move through virtual space by driving around a racetrack) and/or cause changes in behavior within the environment (e.g. by fighting with other characters). The commands or actions of the user thus cause a response in the virtual environment, rather than the user being a passive observer.

Suitably, the server 110 downloads the content 20 to the client device 200. Executing the game code 21 causes the client device 200 to access the data assets 22 in relevant combinations, which then enables the client device 200 to output the appropriate visual representation on a display screen 205. In the example gaming system, these visual representations are then typically output in combination with a coordinated audio stream comprising background music and environmental audio (wind, rain), and more specific game-event related audio effects (gunshots, footfalls, engine noise). The interactive environment may be interspersed with previously prepared video sequences (cut scenes) and user interaction points (e.g. menus, maps).

A library device 450, e.g. a storage device within the server 110 or coupled thereto, may be provided to store the content application 20 ready to be downloaded to the client device 200. The library 450 may store many different such content applications 20, giving the user a wide choice of games, or other content, to be downloaded.

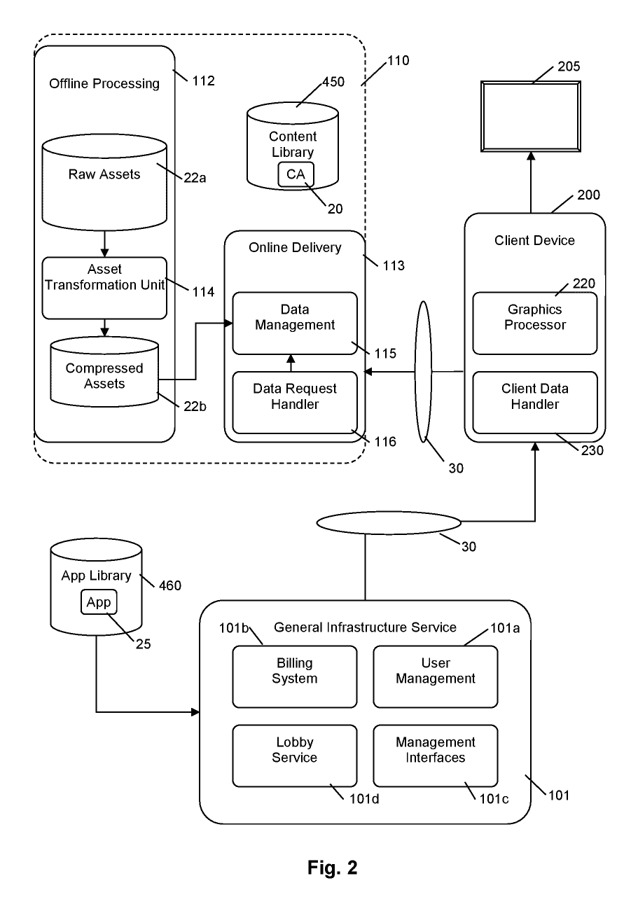

FIG. 2 is a schematic diagram showing the example system architecture in more detail, including an app store infrastructure 101, and a content delivery infrastructure 110.

Suitably, the app store infrastructure 101 provides an app store offering applications 25 (or ‘apps’) from many different developers, which may be stored in an app repository 460. In one example, the app store infrastructure 101 implements Windows App Store offering Windows Apps, as will be familiar to the skilled person.

The app store infrastructure 101 provides support infrastructure to manage the delivery of the apps 25 to the client devices 200. For example, the app store infrastructure server 101 provides services 101a-101d that manage user accounts including authentication and/or authorization functions 101a, billing 101b, developer management interfaces 101c, and lobby services 101d that allow users to move around the system to access the available apps—i.e. games or other content.

Typically, these services may be distributed amongst several physical server devices arranged at physically separate locations or sites. Load-balancing and replication may be used according to the scale of a particular practical implementation.

In this example, the content delivery infrastructure 110 is separate from the app store infrastructure 101 but, as will be discussed in detail below, operates cooperatively to enhance the system. The delivery infrastructure 110 may include an offline processing server 112. Also, the delivery infrastructure 110 may include an online delivery server 113.

The online delivery server 113 suitably includes a data management module 115 and a server-side data request handler 116. In the example gaming system, the data request handler 116 receives data requests originating from the client 200, such as a request for a particular content 20. The data management module 115 handles the dispatch of the content 20, such as a video game, from the content library 450 to the client 200.

In the example embodiment, the client 200 includes, amongst other components, a graphics processor 220 and a client-side data handler 230. Here, the graphics processor 220 takes the 3D graphical data, received in the video game applications 20 from the server 200, or elsewhere, and performs relatively intensive graphical processing to render a sequence of visual image frames capable of being displayed on the visual output device 205 coupled to the client device 200. These frames may be 2D image frames, or 3D image frames, depending on the nature of the visual output device 205. The client-side data handler 230 connects with the server-side data request handler 116 to manage installation and operation of the game content 20 and optionally to exchange other data as well.

In one example, the server 110 holds data assets 22a in their original format as might be provided by a games publisher for a traditional format appropriate to distribution on physical media such as optical disks. However, these original assets 22a are relatively large and can take a long time to download over the network 30. Therefore, the example embodiments may further include an improved mechanism for changing one or more of the original assets into a compressed format. These compressed versions 22b of the assets are then included in the downloadable content 20, and are decompressed by the client 200, i.e. from the compressed format back to the original format, ready to be called by the executing game code 21.

As shown in FIG. 2, the offline processing unit 112 may include an asset transformation unit 114 that optionally and advantageously transforms the original assets 22a, such as complex 3D objects, texture images, audio files and others, into corresponding compressed files 22b. The object transformation unit 114 suitably receives raw asset data 22a and converts or transforms the raw asset data into a transformed format 22b, which can then be added as compressed game assets 22 to the respective content application 20 in the game library 450.

The asset transformation unit 114 suitably operates statically, in advance, so that a set of compressed assets becomes available in the transformed format. As one option, a games developer may supply raw assets 22a, such as 3D objects, in a native high-resolution format such as a detailed polygon mesh. The raw assets 22a may also include texture files (image files) which provide surface texture and detail over the polygon meshes. These objects represent, for example, characters or components of the game such as humans, animals, creatures, weapons, tables, chairs, stairs, rocks, pathways, etc. The object transformation unit 114 then transforms the received objects into the compressed format and provides the compressed assets to be used later. A corresponding decompression unit may be provided at the client device 200, e.g. as part of the client-side data handler 230. The compressed assets are decompressed at the client device 200 and delivered in a suitable format to the graphics processor unit 220. Typically, the compressed assets are returned to their original format, but it is also possible to perform a format conversion. For example, an original bitmap image (.bmp) is compressed using partial differential equations (PDEs) into a compressed format, and a JPEG type image file is restored from the PDE compressed format, on the basis that the graphics processor 220 is able to accept the .jpg image file as a substitute for the original .bmp asset.

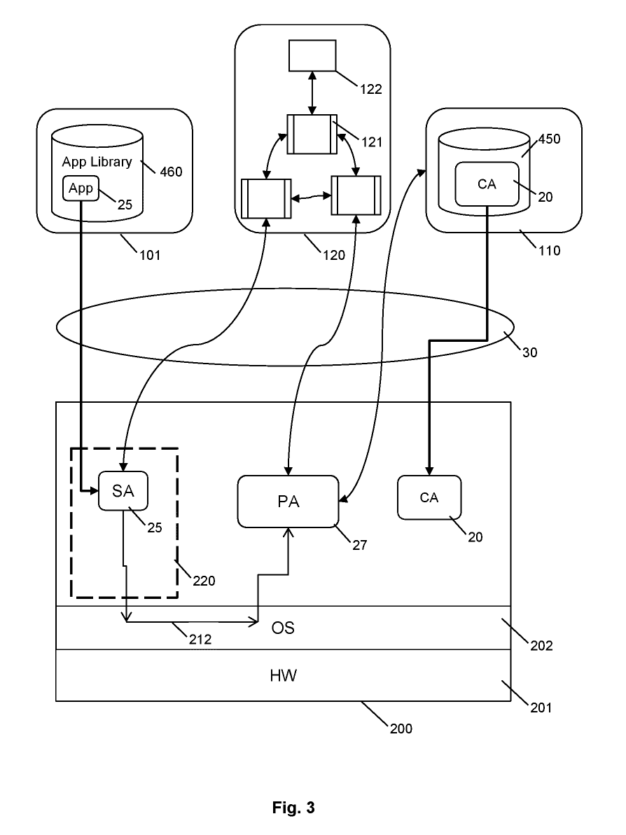

FIG. 3 shows the example system in more detail. As discussed above, the app store infrastructure 101 provides an app store interface to access the app library 460 offering many different applications (‘apps’) 25. One of these apps ‘SA’ 25 is downloaded to the client device 200. Notably, the app 25 is contained within a sandbox 220. For example, the app 25 is provided in the format of ‘.appx’ files, also known as Metro-style apps or Windows Store Apps. These apps are intended to run on Universal Windows Platform (UWP), which provides a runtime environment to support execution of the app. In particular, the UWP provides an Application Programming Interface (API) which allows applications to run on a variety of different host hardware, without needing to be adapted for a specific operating system or hardware device. The downloaded app 25 is constrained by the sandbox 220. In particular, the sandbox 220 prevents the application from making any permanent changes to the runtime environment or underlying system. Also, specific permission is needed in order to access hardware devices such as a camera or microphone, or access folders and files beyond a limited set relevant to the application. Therefore, the sandbox 220 restricts the ability of the application to communicate or interact with other components within the client device 200.

Some forms of the operating system 202 provide a ‘channel’ for messaging internally to for from a sandboxed application. Examples include “intents” or “protocol handlers”. However, these communication mechanisms are usually restrictive and can be unreliable. In particular, it is difficult to confirm that messages are correctly received or acted upon by the intended recipient application.

As shown in FIG. 3, the example architecture further provides a privileged application PA 27. The privileged application 27 is not confined within the sandbox 220. Suitably, the privileged application 27 obtains privileges according to the logged in user, as to a native user application. However, communication between the sandboxed application 25 and the privileged application 27 is still difficult due to the constraints imposed by the sandbox 220.

The example architecture further includes a messaging relay infrastructure, including a plurality of individual messaging servers 121 which together function as a message relay server 120. The relay server 120 is remote from the client device 200 and may be coupled thereto over the network 30 (e.g. the Internet) and functions to provide a communication route between the sandboxed application 25 and the privileged application 27. Based on those communications, the privileged application 27 may now access resources in the client device 200 on behalf of the sandboxed application 25. The privileged application 27 provides controlled access to those resources, as will be discussed in more detail below. When the sandboxed application 25 requires to perform a restricted operation which would otherwise be prevented by the sandbox 220, the sandboxed application 25 makes a request to the relay server 120. The privileged application 27 is also connected to the relay server 120. Messages received by the relay server 120 are delivered directly or via one or more of the messaging servers 121 to pass from the sandboxed application 25 to the privileged application 27. These messages may be filtered for security when they pass through the relay server 120 and/or on receipt by the privileged application 27, to ensure that the requested operation does not leak information to a malicious attacker, or damage or delete any privileged data on the client device 200.

The example embodiment further ensures that the sandboxed application SA 25 and the privileged application PA 27 both reside on the same client device 200. Thus, the relay server 120 functions to ensure that the SA 25 and the PA 27 communicate only with each other when on the same client device 200, and do not communicate with equivalent components on other client devices. In one example, the SA 25 and the PA 27 both require the user to provide security credentials (e.g. log on with username and password). However, this can be burdensome for the user. Therefore, the example embodiments instead infer that the SA 25 and the PA 27 are both on the same client device 200 through a combination of client identifiers. These client identifiers may include hardware identifiers such as, for example, MAC addresses of network adapters visible to both the SA 25 and the PA 27. The client identifiers may include identifiers provided by the operating system. The client identifiers may include tokens passed using a channel within the client device 200. Further, the client identifiers may include IP addresses that the device presents externally, whether on a Local Area Network (LAN) or a Wide Area Network (WAN). The example embodiments further may use timing of connections being made by the SA 25 and PA 27 to the relay server 20 to infer that both components are present on the same client device.

In one example, as shown in FIG. 3, an identity server 122 may be provided which functions to maintain a record of the client identifier(s) or ‘identity’ of each connected client device 200. The identity server 122 assists to improve usability and security, in particular to support the process of creating paired communication channels when a user logs back in. The identity server 122 further helps to scale the system, in that the identity server 122 is able to hand out a registered client identity of the relevant client device 200 to one of the relay servers 122 which is nearest the user, and thus improve efficiency. The identity server 122 also assists in scenarios where a configuration of a particular client device 122 is changed, such that the pairing identifier is now different. For example, if the user changes their PC from using Wi-Fi to wired communications, the identity server 122 updates a list of valid identities for that client device 200. An alternative example would be if a user changed their graphics card, the system tracks these hardware changes as part of the registered client identity, which is conveniently held by the identity server 122.

In some examples, the operating system 202 may provide a channel for communication internally within the client device 200. Although not sufficient to achieve the necessary functional operation discussed herein, the internal communication channel 212 may be exploited usefully. In particular, the sandboxed application 25 may use the channel to send an alert to the privileged application 27, notifying the privileged application 27 to expect imminently receipt of a message from the relay server 120. Thus, the privileged application 27 may promptly connect to the relay server 120 to receive the expected message. The internal communication channel thus minimizes the time and resource needed to maintain the connection from the privileged application 27 to the relay server 120, and increases resilience of the external communication via the relay server 120.

In practical embodiments there is a large population of client devices 200, such as many millions of devices. However, the number of messages to be sent is relatively small and infrequent for any one client device. Therefore, the relay server 120 has been provided with multiple individual messaging servers 121, which can be scaled to run according to demand at the time. A central directory may be maintained to determine a destination for each of the messages.

There are many possible communication mechanisms for establishing communication between the client device 200 and the relay server 120 over the network 30. For example, Websockets, long polling (BOSH), or lower level TCP/IP protocols. Typically, these communication mechanisms benefit from an ability to sustain an open connection for a long time, but without requiring significant processing power at the sender or recipient devices.

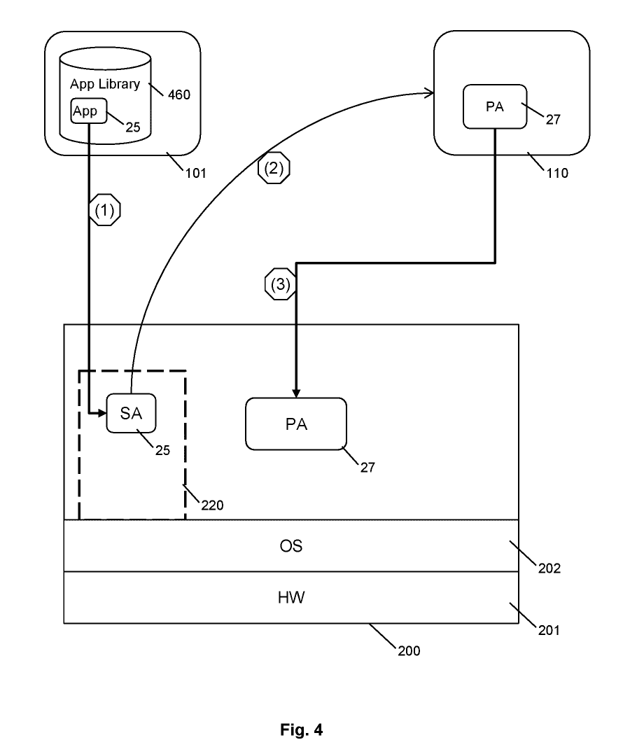

FIG. 4 shows the example system in further detail, explaining a process operated by the system. At stage (1), the client device 200 connects to the app store 101 and downloads the application 25 to reside within the sandbox 220. Executing the sandboxed application 25 may open a browser window for user interaction. At stage (2), user interactions with the sandboxed application 25 via the browser window cause a request to be generated to the content server 110 for download of the privileged application 27. At stage (3), the privileged application 27 is downloaded and installed on the client device 200. Suitably, the privileged application 27 is installed with native privileges derived from the user account, rather than in a restrictive sandbox 220. Typically, the client device 200 will prompt the user to provide additional authentication (e.g. again enter their login credentials), to permit the install. In this example, the privileged application 27 is provided from the content server 110, which will later also supply the content application 20, but other sources are also possible.

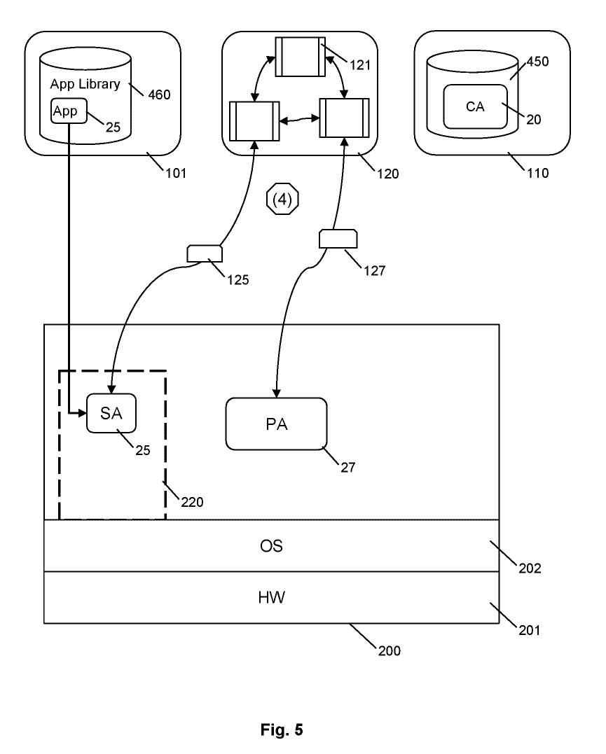

FIG. 5 shows a further process within the example system. The client device 200 having both the sandboxed application 25 and the privileged application 27 now installed therein may establish communication with the relay server 120 discussed above to exchange messages 125, 127. Here, the one or more messaging servers 121 operate to relay the messages from one application to the other. Thus, the external messaging channel is established between the sandboxed application (UWP app) 25 and the privileged application 27. This communication allows the PA 27 to function as a hub on the client device 200.

At stage (4), the sandboxed application 25 exchanges one or more messages 125 with the relay server 120, which are passed to the privileged application 27. In this example, the messages request a list of installed content applications, i.e. a list of content applications which have been installed locally on the client device 200. At this point, as illustrated in FIG. 5, no applications have been installed so far, which indicates that the list is empty. The sandboxed application 25 may now use the browser interface to display this status to the user. If desired, the session may now be completed, and execution of the sandboxed application 25 may be terminated. Suitably, the sandboxed application 25 performs the communication procedure of stage (4) at initialization, or as a refresh, to establish a list of currently installed content applications 20 on the client device 200.

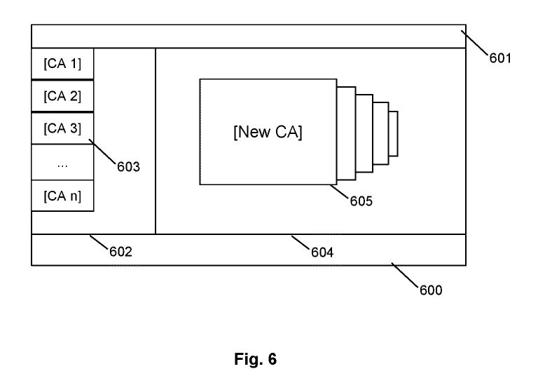

FIG. 6 is a schematic example of a user interface for displaying content application status information. In particular, the user interface 600 may be displayed on the display device 205 described above, such as in a browser window 601 in a browser application. This browser window 601 may provide a first area 602 which displays CA list items 604 of installed content applications, such as in the form of graphical titles or text labels (name, description, etc.). A second area 604 may be used to display additional available content items 605 which have not yet been installed, again such as by using content display titles or graphical tiles. At an initial stage the first area 602 may be empty. The computer device 200 receives a selection from the user to select one of the offered new content items 605. Thus, the sandboxed application 25 receives a user instruction to now download the relevant content application CA 20.

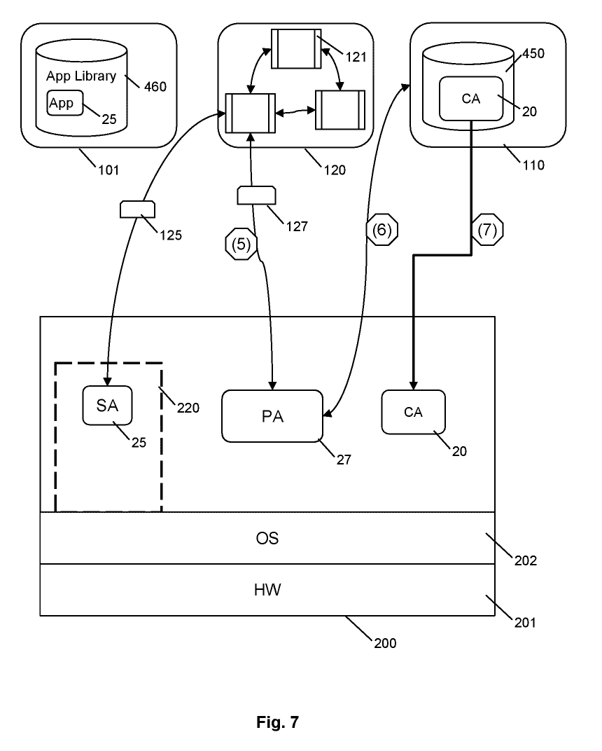

FIG. 7 illustrates a process wherein, at stage (5), the sandboxed application 25 sends a request via the relay server 120 to reach the privileged application 27, requesting installation of a selected content application CA 20. The privileged application 27 receives the install request and now contacts the content server 110, as at stage (6), to request download of the requested content application 20. Notably, the sandboxed application 25 does not itself cause the content application 20 to be downloaded, due to the restrictions of the sandbox 220. Instead, the privileged application 27 is able to download and install the content application 20 as a native application, as at stage (7), ideally with minimal user interaction. The privileged application 27 may suitably send a return message via the relay server 120 to the sandboxed application 25, providing status updates as to progress. As at stage (4) noted above, the sandboxed application 25 may now include the newly installed content application 20 within the first area 602 of the user interface 601. The user interface may display a status of the content application 20 as being installed and ready to run.

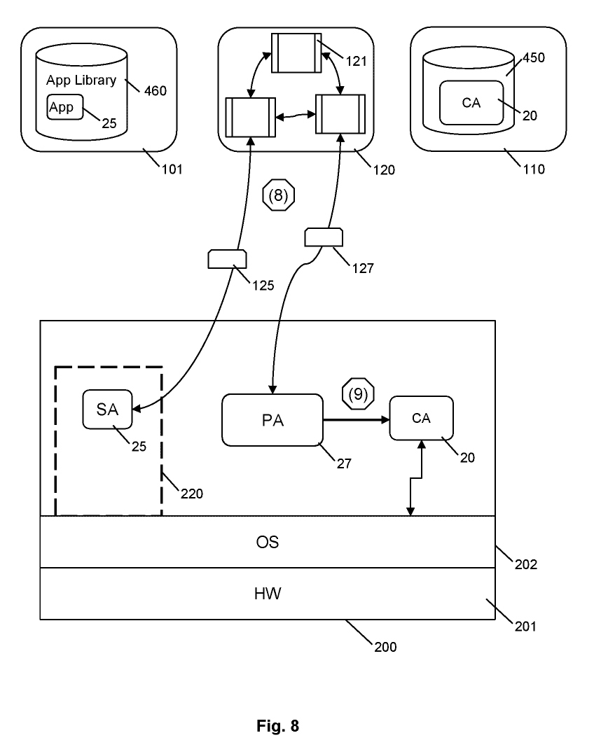

As shown in FIG. 8, the sandboxed application 25 may receive a user command instructing launch of one of the installed content applications. As at stage (8), the sandboxed application 25 sends a message via the relay server 120 to reach the privileged application 27 requesting launch of the selected content application CA 20. At stage (9), the privileged application 27 launches the content application 20 as a native application. The CA 20, running on the operating system 202 with relevant privileges, is able to function as intended.

The same mechanism may also be used to uninstall an installed content application. The sandboxed application 25 receives an appropriate uninstall command, which is passed by messages through the relay server 120 to the privileged application 27. The privileged application 27 receives the uninstall request and in response uninstalls the content application 20. Again, a status may be reported back to the sandboxed application 25.

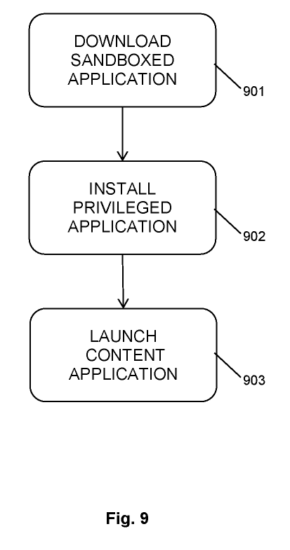

FIG. 9 is a schematic low diagram of an example method operated by the described system. Step 901 comprises downloading a sandboxed application to be contained within a sandbox on the client device 200. Step 902 comprises downloading and operating a privileged application on the client device. The privileged application is not contained within the sandbox. Step 903 comprises downloading and installing a content application on the client device by the privileged application in response to a request from the sandboxed application received via a relay server external to the client device and arranged to pass messages between the sandboxed application and the privileged application of the client device.

The described system architecture and methods allow applications to be obtained from an app store and contained within a sandbox in the usual manner. However, operational functionality is ensured of a desired content application, such as a video game, assisted by the privileged application. These and other benefits of the claimed invention will be apparent from reading the discussion herein.

The invention as described herein may be industrially applied in a number of fields, including particularly the field of delivering video games across a network from a server device to client device.

The example embodiments have many advantages and address one or more problems of the art as described above. In particular, the example embodiments address the problem of providing demo versions of a full game onto a client device, which are particularly relevant with video gaming environments. The example embodiments address piracy and security issues.

At least some of the example embodiments may be constructed, partially or wholly, using dedicated special-purpose hardware. Terms such as ‘component’, ‘module’ or ‘unit’ used herein may include, but are not limited to, a hardware device, such as a Field Programmable Gate Array (FPGA) or Application Specific Integrated Circuit (ASIC), which performs certain tasks.

Elements of the example embodiments may be configured to reside on an addressable storage medium and be configured to execute on one or more processors. That is, some of the example embodiments may be implemented in the form of a computer-readable storage medium having recorded thereon instructions that are, in use, executed by a computer system. The medium may take any suitable form but examples include solid-state memory devices (ROM, RAM, EPROM, EEPROM, etc.), optical discs (e.g. Compact Discs, DVDs, Blu-Ray discs and others), magnetic discs, magnetic tapes and magneto-optic storage devices.

In some cases the medium is distributed over a plurality of separate computing devices that are coupled by a suitable communications network, such as a wired network or wireless network. Thus, functional elements of the invention may in some embodiments include, by way of example, components such as software components, object-oriented software components, class components and task components, processes, functions, attributes, procedures, subroutines, segments of program code, drivers, firmware, microcode, circuitry, data, databases, data structures, tables, arrays, and variables.

Further, although the example embodiments have been described with reference to the components, modules and units discussed herein, such functional elements may be combined into fewer elements or separated into additional elements.

Although a few example embodiments have been shown and described, it will be appreciated by those skilled in the art that various changes and modifications might be made without departing from the scope of the invention, as defined in the appended claims.

1. A computer system, comprising:
a client device having hardware including at least a processor and a memory configured to download a sandboxed application and to contain the sandboxed application within a sandbox, and configured to operate a privileged application which is not contained within the sandbox on the client device;
a relay server external to the client device, arranged to pass messages between the sandboxed application and the privileged application of the client device; and
a content server arranged to provide a content application, which is downloaded and installed on the client device by the privileged application in response to a request from the sandboxed application received via the relay server.

2. The computer system of claim 1, wherein the client device when executing the sandboxed application opens a user interface to receive user commands, including a command requesting install of the privileged application in response to which the client device downloads and installs the privileged application and establishes communication from the sandboxed application and the privileged application to the relay server.

3. The computer system of claim 1, wherein the client device when executing the sandboxed application receives user commands, including a command requesting install of the content application in response to which the client device passes a content install request message from the sandboxed application via the relay server to the privileged application and the privileged application in response to the content install request message downloads and installs the content application from the content server.

4. The computer system of claim 1, wherein the client device when executing the sandboxed application initiates a list request message from the sandboxed application via the relay server to the privileged application and the privileged application in response provides a list of the content applications which are currently installed on the client device.

5. The computer system of claim 1, wherein the client device when executing the sandboxed application opens a user interface which displays in a first area a list of content application currently installed on the client device and in a second area a list of content application available from the content server to be installed on the client device.

6. The computer system of claim 1, wherein the client device when executing the sandboxed application receives user commands, including a command requesting launch of a selected content application installed on the client device in response to which the client device passes a content launch request message from the sandboxed application via the relay server to the privileged application and the privileged application in response to the content launch request message launches the selected content application on the client device.

7. The computer system of claim 1, wherein the client device when the sandboxed application is executed is configured to send a notification via a channel of internal communication within the client device between the sandboxed application and the privileged application, and the privileged application is configured to connect to the relay server in response to the notification to receive a message originated from the sandboxed application.

8. The computer system of claim 1, wherein the privileged application as a native user application obtains privileges derived from a security account of a logged in user.

9. The computer system of claim 1, wherein the content application as a native user application obtains privileges derived from a security account of a logged in user.

10. The computer system of claim 1, wherein the content application comprises graphical assets and code executable by the client device to provide interactive multimedia content.

11. The computer system of claim 1, wherein the content application is a video game.

12. The computer system of claim 1, wherein the client device is configured to download the sandboxed application from an app store infrastructure.

13. The computer system of claim 1, wherein the relay server includes a plurality of messaging servers which relay the messages between each other, and wherein the sandboxed application is coupled to a first of the messaging servers while the privileged application is coupled to another of the messaging servers.

14. The computer system of claim 1, wherein the messages received by the relay server are filtered for security when passing through the relay server and/or on receipt by the privileged application.

15. The computer system of claim 1, wherein the relay server is configured to confirm that the sandboxed application and the privileged application are both resident on the same client device when passing messages therebetween.

16. The computer system of claim 1, wherein the relay server is configured to obtain and compare a client identifier from each of the sandboxed application and the privileged application.

17. The computer system of claim 1, wherein the relay server is configured to examine a timing of connections confirming that the sandboxed application and the privileged application are both resident on the same client device.

18. The computer system of claim 1, further comprising an identity server configured to maintain, for each client device, a client identity comprising a plurality of client identifiers.

19. A client device, comprising:
hardware including at least a processor and a memory configured to:
download a sandboxed application and to contain the sandboxed application within a sandbox;
operate a privileged application which is not contained within the sandbox on the client device; and
download and install a content application on the client device by the privileged application in response to a request from the sandboxed application received via a relay server external to the client device and arranged to pass messages between the sandboxed application and the privileged application of the client device.

20. A method for a client device in a computer system, the method comprising:
downloading a sandboxed application and containing the sandboxed application within a sandbox;
operating a privileged application which is not contained within the sandbox on the client device; and
downloading and installing a content application on the client device by the privileged application in response to a request from the sandboxed application received via a relay server external to the client device and arranged to pass messages between the sandboxed application and the privileged application of the client device.
